(19) United States
(12) Patent Application Publication
(10) Pub. No.: US 2024/0375955 A1
(43) Pub. Date: Nov. 14, 2024

(54) PHOTOCHEMICAL HYDROGEN PEROXIDE PREPARATION PROCESS PERFORMED BY COMBINING PHOTOAUTOXIDATION AND PHOTOCATALYTIC REACTIONS

(71) Applicant: KOREA INSTITUTE OF SCIENCE AND TECHNOLOGY, Seoul (KR)

(72) Inventors: Jee Hye BYUN, Seoul (KR); Dong Ki LEE, Seoul (KR); Byeong Cheul MOON, Seoul (KR); Bayarkhuu BOLORMAA, Seoul (KR)

(21) Appl. No.: 18/236,475

(22) Filed: Aug. 22, 2023

(30) Foreign Application Priority Data
May 9, 2023 (KR) 10-2023-0060003

(51) Int. Cl. C01B 15/026; B01J 31/06; B01J 35/00

(52) U.S. Cl. CPC C01B 15/026; B01J 31/06; B01J 35/39

(57) ABSTRACT

The present invention relates to a method and process for preparing hydrogen peroxide, and more particularly, to a photochemical hydrogen peroxide preparation process performed by combining photoautoxidation and photocatalytic reactions in an organic reaction solution to which a catalytic amount of water is added using solar light as a main energy source.

### CROSS-REFERENCE TO RELATED APPLICATION

This application claims priority to and the benefit of Korean Patent Application No. 10-2023-0060003 filed in the Korean Intellectual Property Office on May 9, 2023, the entire contents of which are incorporated herein by reference.

### BACKGROUND OF THE INVENTION

### (a) Field of the Invention

The present invention relates to a method and process for preparing hydrogen peroxide, and more particularly, to a photochemical hydrogen peroxide preparation process performed by combining photoautoxidation and photocatalytic reactions in an organic reaction solution to which a catalytic amount of water is added using solar light as a main energy source.

### (b) Description of the Related Art

In the industrial production of hydrogen peroxide, more than 90% of the total production of hydrogen peroxide has been obtained by an anthraquinone autoxidation process. As the process is performed under reaction conditions of a high temperature of 50° C. or higher and a high pressure of 4 bar or more, a large amount of energy and a high cost are required. In addition, the use of a rare metal catalyst such as palladium (Pd) and hydrogen (H2) gas in the process may be a factor that increases cost requirements. In particular, rare metals used as catalysts may not be easy to procure due to high dependence on imported resources.

The anthraquinone autoxidation process causes not only economic problems but also environmental problems. The high-temperature and high-pressure process may cause environmental problems such as production of a large amount of carbon and production of toxic reaction by-products due to the use of the metal catalyst. In addition, highly concentrated hydrogen peroxide has an explosion risk due to an abnormal decomposition reaction.

A demand for an eco-friendly low-carbon hydrogen peroxide production technology that solves the problems of the process itself and is effective in the industrial field has increased. Since a relatively low concentration (<2 wt %) of hydrogen peroxide is actually used in a water treatment plant or a semiconductor cleaning process, which is a large demand for hydrogen peroxide, the effectiveness of the technology for producing hydrogen peroxide on site in a dispersed form may be high. Currently, an electrochemical technology and a photocatalytic technology are used as eco-friendly technologies for producing hydrogen peroxide, but are difficult to put into practical use due to clear limitations on performance, production scale, and purification cost.

It is required for a hydrogen peroxide production technology that may be used in an industrial site to produce hydrogen peroxide in an eco-friendly low-carbon manner and to produce hydrogen peroxide at a level required in the actual industry.

### SUMMARY OF THE INVENTION

The present invention has been made in an effort to provide an eco-friendly low-carbon hydrogen peroxide preparation process in the form of simulating an industrial thermochemical hydrogen peroxide production method by a photochemical method and to achieve ultra-high efficiency of hydrogen peroxide production capacity through the process.

Specifically, the present invention has been made in an effort to provide a hydrogen peroxide preparation process by solar light using an organic working solution (OWS) containing an aromatic alcohol, an aromatic carbonyl, and a metal-free polymer photocatalyst. An exemplary embodiment of the present invention provides a hydrogen peroxide preparation process performed by combining photoautoxidation and photocatalytic reactions using solar light, the hydrogen peroxide preparation process including: preparing a mixed solution by mixing a photocatalyst and a photoautoxidative organic reaction solution; forming a mixed solution by injecting the prepared mixed solution into a reactor; forming an oxygen-saturated mixed solution by supplying oxygen to the reactor; and producing hydrogen peroxide by irradiating the oxygen-saturated mixed solution with light.

In the hydrogen peroxide preparation process according to an exemplary embodiment, hydrogen peroxide may be produced through a photoautoxidation reaction of an organic reaction solution containing an aromatic carbonyl that absorbs solar light.

In the organic reaction solution, an aromatic alcohol is oxidized by light energy, and at the same time, oxygen molecules are reduced to produce hydrogen peroxide, such that energy consumption may be minimized.

Since it is a reaction in which photoinduced oxidation and photocatalytic mechanisms are combined, the hydrogen peroxide production capacity by solar light may be maximized.

The photocatalyst contained in the reaction solution may improve overall reaction efficiency by supplying electrons and hydrogen ions while mediating oxidation/reduction of the aromatic alcohol.

A metal-free polymer catalyst is used as the photocatalyst and hydrogen peroxide is produced in an environment in which there are no metals in reactants, and therefore, there is no possibility of toxic substances produced by metals or contamination of hydrogen peroxide produced.

In addition, the process is a reaction at room temperature and normal pressure, and therefore, production of by-products may be minimized and an explosion risk is low.

In the hydrogen peroxide production reaction and process, oxidation and reduction products may be obtained as oxidation of an aromatic alcohol, which is an organic molecule, and reduction of oxygen (production of hydrogen peroxide) occur simultaneously, and thus, there is an advantage in that the oxidized organic molecules may be obtained without being reduced again and recycled as a photocatalyst in an organic reaction solution or used as a useful compound.

### BRIEF DESCRIPTION OF THE DRAWINGS

FIG. 1 illustrates a schematic view of a hydrogen peroxide preparation process according to an exemplary embodiment of the present invention.

FIG. 2 illustrates a hydrogen peroxide production mechanism in a hydrogen peroxide preparation process performed by combining photoautoxidation and photocatalytic reactions.

FIG. 3 illustrates a reaction formula of production of a polymer photocatalyst CTF-Ph through solid-phase polymerization of dicyanobenzene in an acid atmosphere.

FIG. 4 illustrates light absorption characteristics and a band gap of the polymer photocatalyst CTF-Ph.

FIG. 5 illustrates a reduction potential of oxygen, an oxidation potential of benzyl alcohol, and an oxidation/reduction potential of the polymer photocatalyst CTF-Ph prepared according to a preparation example of the present invention.

FIG. 6 illustrates a solar reactor experimental device.

FIG. 7 illustrates production of hydrogen peroxide according to a content of water with respect to an aromatic alcohol in a combination of polymer photocatalytic and solar autoxidation reactions in an organic reaction solution.

FIG. 8 illustrates production of benzaldehyde, which is an oxidized organic product, according to a content of water with respect to an aromatic alcohol in a combination of polymer photocatalytic and solar autoxidation reactions in an organic reaction solution.

FIG. 9 illustrates solar-to-chemical conversion efficiency (SCC efficiency) of a 3-hour production process according to a content of water with respect to an aromatic alcohol in a combination of polymer photocatalytic and solar autoxidation reactions in an organic reaction solution.

FIG. 10 illustrates production of hydrogen peroxide according to a content of water with respect to an aromatic alcohol in a solar autoxidation reaction in an organic reaction solution.

FIG. 11 illustrates production of benzaldehyde, which is an oxidized organic product, according to a content of water with respect to an aromatic alcohol in a solar autoxidation reaction in an organic reaction solution.

FIG. 12 illustrates solar-to-chemical conversion efficiency (SCC efficiency) of a 3-hour production process according to a content of water with respect to an aromatic alcohol in a solar autoxidation reaction in an organic reaction solution.

FIG. 13 illustrates production concentrations of hydrogen peroxide and an oxidized organic product (benzaldehyde, BzCHO) through continuous irradiation with solar light for 50 hours, and solar-to-chemical conversion efficiency (SCC efficiency) in a combination of polymer photocatalytic and solar autoxidation reactions in an organic reaction solution.

FIG. 14 illustrates production of hydrogen peroxide according to a content of water with respect to an aromatic alcohol in a combination of inorganic photocatalytic TiO₂ and solar autoxidation reactions in an organic reaction solution.

FIG. 15 illustrates production of benzaldehyde, which is an oxidized organic product, according to a content of water with respect to an aromatic alcohol in a combination of inorganic photocatalytic TiO₂ and solar autoxidation reactions in an organic reaction solution.

FIG. 16 illustrates solar-to-chemical conversion efficiency (SCC efficiency) of a 3-hour production process according to a content of water with respect to an aromatic alcohol in a combination of inorganic photocatalytic TiO₂ and solar autoxidation reactions in an organic reaction solution.

FIG. 17 illustrates a decomposition behavior of hydrogen peroxide (10 mM) by a photocatalyst contained in an organic reaction solution under oxygen-free argon conditions when irradiated with solar light.

FIG. 18 illustrates a change in hydrogen peroxide production capacity of a polymer photocatalyst CTF-Ph according to a change in type of electron donor (water/10% IPA/10% BzOH) contained in an aqueous reaction environment.

FIG. 19 illustrates a rotating ring-disk electrode voltammogram of a polymer photocatalyst CTF-Ph under aqueous reaction conditions (0.1 M phosphate buffer (KPi, pH 7.2)) (Pt ring electrode applied voltage: 1.0 V vs. Ag/AgCl).

FIG. 20 illustrates a rotating ring-disk electrode voltammogram of a polymer photocatalyst CTF-Ph under organic-based reaction conditions (0.1 M benzyl alcohol (BzOH) acetonitrile (MeCN)-0.1 M tetrabutylammonium hexafluorophosphate (TBAPF₆)).

FIG. 21 illustrates polymer photocatalyst comparative groups (CTF-Th, CTF-BPh, and g-C₃N₄) that may be applied to the hydrogen peroxide preparation process of the present invention in which solar autoxidation and photocatalytic reactions are combined and respective structures thereof.

FIG. 22 illustrates oxidation/reduction potentials of the polymer photocatalyst comparative groups CTF-Th, CTF-BPh, and g-C₃N₄.

FIG. 23 illustrates production capacity of hydrogen peroxide and an oxidized organic product (BzCHO) of the polymer photocatalyst comparative groups (CTF-Th, CTF-BPh, and g-C₃N₄) in an organic reaction solution (BLK: solar autoxidation efficiency of organic reaction solution alone).

FIG. 24 illustrates production of hydrogen peroxide according to a concentration of a polymer photocatalyst in an organic reaction solution in the hydrogen peroxide preparation process of the present invention.

### DETAILED DESCRIPTION OF THE EMBODIMENTS

Terminologies used herein are to mention only a specific exemplary embodiment, and are not to limit the present invention. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

All terms including technical terms and scientific terms used herein have the same meanings as understood by those skilled in the art to which the present invention pertains.

The term “organic working solution (OWS)” used herein may be understood to have the same meaning and effect as an organic reaction solution.

The term “polymer photocatalyst” used herein may be understood to have the same meaning and effect as a metal-free polymer photocatalyst and a metal-free polymer catalyst.

Hereinafter, exemplary embodiments of the present invention will be described in detail. However, these exemplary embodiments are provided as examples, and the present invention is not limited by these exemplary embodiments and is defined by only the scope of the claims to be described below.

A hydrogen peroxide preparation process performed by combining photoautoxidation and photocatalytic reactions using solar light according to an exemplary embodiment of the present invention may include: preparing a mixed solution by mixing a photocatalyst and a photoautoxidative organic reaction solution; forming an oxygen-saturated mixed solution by injecting the prepared mixed solution into a reactor and then supplying oxygen to the reactor; and producing hydrogen peroxide by irradiating the oxygen-saturated mixed solution with light.

In the hydrogen peroxide preparation process of the present invention, oxygen is charged into the organic reaction solution and the organic reaction solution is irradiated with solar light to obtain hydrogen peroxide and an aromatic carbonyl compound as main products.

Hydrogen peroxide may be produced by converting oxygen from photoautoxidation and photocatalytic reactions in an organic reaction solution containing an aromatic alcohol, an organic solvent, an aromatic carbonyl compound, and a small amount of water.

In addition, hydrogen peroxide prepared according to an exemplary embodiment of the present invention is extracted, filtered, and purified from an organic solution using a large amount of water, such that the total organic carbon (TOC) corresponding to contaminants may be reduced by up to 98.4%, and a concentration of organic contaminants may be reduced to 32.7 ppm. Therefore, a hydrogen peroxide solution with a purity of up to 99.99673% may be obtained.

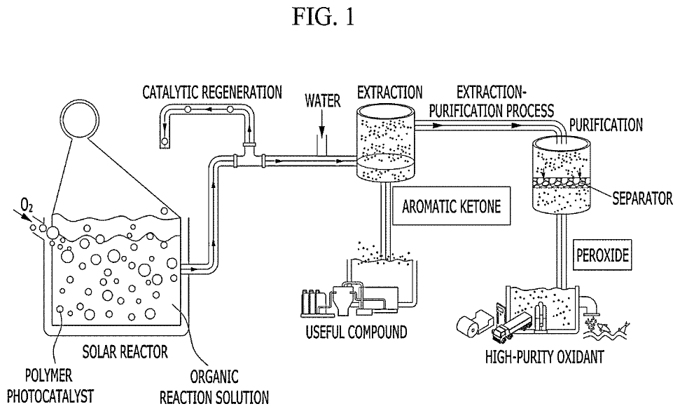

A schematic view of the hydrogen peroxide preparation process implemented in the present invention is illustrated in FIG. 1.

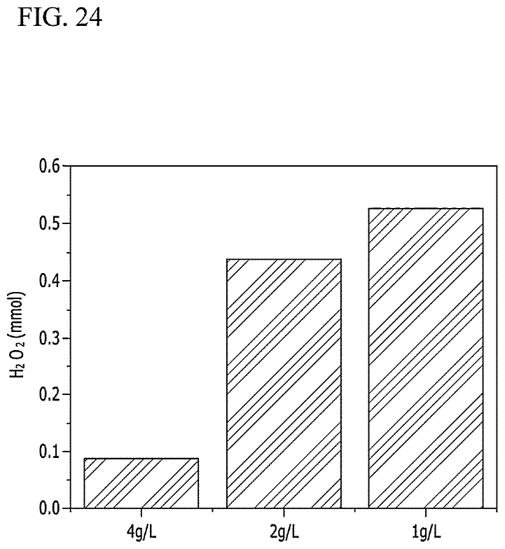

In the preparing of the mixed solution by mixing the photocatalyst and the photoautoxidative organic reaction solution, a concentration of the photocatalyst dispersed in the photoautoxidative organic reaction solution may be 0.1 g/L to 4.0 g/L. Referring to FIG. 24, the concentration of the photocatalyst dispersed in the photoautoxidative organic reaction solution may be preferably 1.0 g/L to 4.0 g/L. When a polymer photocatalyst is dispersed at a concentration of 4.0 g/L or more, a light transmittance is reduced, resulting in a reduction in efficiency. When the concentration of the polymer photocatalyst is reduced to less than 1.0 g/L, the contribution of the photocatalyst in the hydrogen peroxide production process is reduced, and thus, there is a limit to supplying electrons and hydrogen ions in the reaction. In Example 1-1, a polymer photocatalyst was injected into an organic reaction solution at a concentration of 1.6 g/L.

The photocatalyst contained in the organic reaction solution may serve to supply electrons and hydrogen ions in the photoautoxidation process.

In the preparing of the mixed solution by mixing the photocatalyst and the photoautoxidative organic reaction solution, the photocatalyst that may be mixed may be a polymer photocatalyst, and the polymer photocatalyst may be one or more selected from CTF-Ph, CTF-Th, CTF-BPh, and graphitic carbon nitride (g-C₃N₄).

In the preparing of the mixed solution by mixing the photocatalyst and the photoautoxidative organic reaction solution, a reduction potential of the photocatalyst may be included in a range of −1.25 to −0.50 V vs. Ag/Ag⁺, and an oxidation potential of the photocatalyst may be included in a range of 1.65 to 2.70 V vs. Ag/Ag⁺. This is to satisfy an oxygen reduction potential of −0.53 V vs. Ag/Ag⁺ and an aromatic alcohol oxidation potential of 1.7 to 2.7 V vs. Ag/Ag⁺.

When the reduction potential of the photocatalyst is within the above range, oxygen may be reduced in the organic reaction solution. In addition, when the oxidation potential of the photocatalyst is within the above range, organic molecules may be oxidized in the organic reaction solution.

The photocatalyst reaction includes using a polymer photocatalyst containing organic molecules without containing a metal, and the photocatalyst may produce hydrogen peroxide by reducing oxygen and oxidizing an aromatic alcohol in an organic reaction solution while exhibiting electronic characteristics satisfying an oxidation/reduction potential that enables oxygen reduction and aromatic alcohol oxidation to occur.

The photocatalyst used in an exemplary embodiment of the present invention is composed of a combination of organic molecules having different electronic characteristics, such that the oxidation/reduction potential may be easily controlled. In addition, unlike an inorganic photocatalyst, the photocatalyst may not re-reduce or decompose hydrogen peroxide produced. When an inorganic photocatalyst is used, decomposition of hydrogen peroxide may occur during the process, and thus, it is preferable to use a polymer photocatalyst to prevent undesired decomposition of hydrogen peroxide.

The polymer photocatalysts may be variously combined according to electron acceptor and electron donor monomer unit elements.

Therefore, the polymer photocatalyst presented in the present invention is not limited to CTF-Ph, and a polymer photocatalyst that satisfies the potential conditions described above may be included and applied to the hydrogen peroxide preparation process of the present invention.

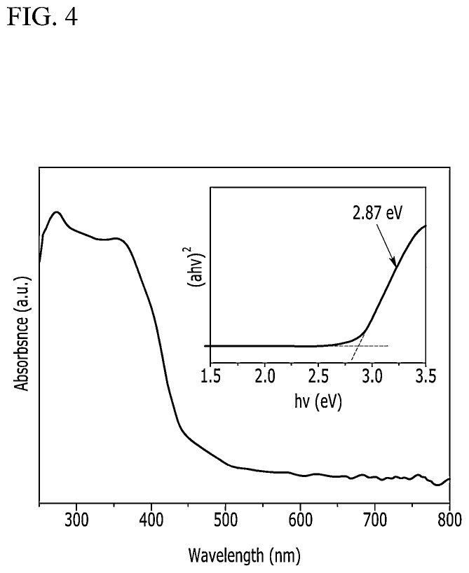

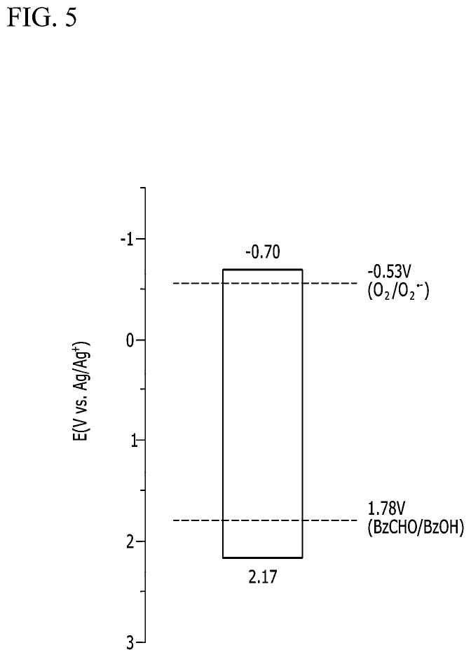

CTF-Ph prepared according to a preparation example of the present invention may have a band gap of 2.87 eV, a reduction potential of −0.7 V vs. Ag/Ag⁺, and an oxidation potential of 2.17 V vs. Ag/Ag⁺. The above potential is a potential at which oxygen reduction and aromatic alcohol oxidation may be sufficiently performed, and is illustrated in FIGS. 4 and 5.

In the preparing of the mixed solution by mixing the photocatalyst and the photoautoxidative organic reaction solution, the photoautoxidative organic reaction solution may contain an aromatic alcohol, an organic solvent, and water. The organic reaction solution may further contain an aromatic carbonyl compound.

The aromatic carbonyl compound may be one or more selected from an aromatic ketone and an aromatic aldehyde.

The aromatic alcohol may function to provide a hydrogen atom to the aromatic carbonyl compound.

The aromatic alcohol may be one or more selected from the group consisting of benzyl alcohols substituted with electron-withdrawing and electron-donating functional groups.

The benzyl alcohol substituted with a functional group may be one or more selected from benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol. In this case, a benzyl alcohol substituted with fluorine refers to an aromatic alcohol containing an electron-withdrawing substituent, and a benzyl alcohol substituted with a methyl group refers to an aromatic alcohol containing an electron-donating substituent. Therefore, the benzyl alcohol substituted with a functional group may be expanded to substituted benzyl alcohol containing electron-withdrawing and electron-donating substituents at positions 2, 3, and 4 of the benzene ring of benzyl alcohol. Examples of the electron-withdrawing substituent include halogen (—X), nitrile (—CN), nitro (—NO₂), ammonium (NR₃⁺), carboxyl (—COOH), ether (—COR), and a sulfone group (—SO₃H), and examples of the electron-donating substituent include alcohol (—OH), amine (—NH₂), methoxy (—OMe), and an alkyl group (—R).

The aromatic alcohol may be partially oxidized and may contain an aromatic carbonyl compound in an amount of 0.1 to 0.2 wt % with respect to the total weight of the aromatic alcohol. In addition, the aromatic carbonyl compound contained in the aromatic alcohol may act as a catalyst, which is an auto-catalyst to become an oxidation reaction product in an organic reaction solution.

As the hydrogen peroxide preparation process proceeds, an aromatic carbonyl compound may be obtained as an oxidation product in the organic reaction solution, and the aromatic carbonyl compound may be recycled as a catalyst or utilized as a useful compound.

The aromatic carbonyl compound may be contained in an amount of 0.001 wt % to 30 wt % with respect to the total weight of the mixture of the aromatic alcohol, organic solvent, water, and additionally included aromatic carbonyl compound.

The aromatic carbonyl compound additionally mixed with the organic reaction solution containing an aromatic alcohol, an organic solvent, and water described above may be, as a group of an aromatic ketone and an aromatic aldehyde, one or more selected from benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, anthraquinone, fluorenone, and acetophenone.

The organic solvent may have a high solubility of oxygen, and the solubility of oxygen may be 1 mM to 15 mM based on 1 atm. When the solubility of oxygen in the organic solvent is within the above range, an oxygen concentration in the organic reaction solution increases, such that the oxygen reduction reaction increases and a production rate of hydrogen peroxide increases, and when the solubility of oxygen in the organic solvent is less than the above range, the production rate of hydrogen peroxide decreases. In order for the solubility of oxygen to be greater than the above range, an oxygen gas pressure should be increased, and thus, energy is additionally consumed. The organic solvent may be one or more selected from trifluorotoluene, acetonitrile, methanol, ethanol, tert-butanol, 1-propanol, 2-propanol, acetone, ethyl acetate, tert-amyl alcohol, 1-butanol, petroleum ether, diethyl ether, pentane, pentanol, cyclohexane, n-hexane, octane, octanol, decane, decanol, heptane, heptanol, dichloromethane, chloroform, tetrahydrofuran, 1,4-dioxane, dimethyl sulfoxide (DMSO), dimethylformamide, benzene, toluene, xylene, and styrene.

The organic solvent may include a hydrophobic organic solvent. The hydrophobic organic solvent is a group that does not mix well with water, and an octanol-water partition coefficient (log P) value of the hydrophobic organic solvent represented by the following Equation 1 is 0 or greater. When an organic reaction solution is prepared using an organic solvent having Log P of 0 or greater, hydrogen peroxide produced after the hydrogen peroxide production reaction may be extracted with water.

Octanol-water partition coefficient=log P=log([C_{oct}]/[C_{water}]) [Equation 1]

In Equation 1, [C_{oct}] represents a molar concentration of an organic solvent dissolved in an octanol layer, and [C_{water}] represents a molar concentration of an organic solvent dissolved in a water layer.

A small amount of water may be contained in the organic reaction solution, and the small amount of water may function to reduce an oxidation potential by hydrogen bonding with the aromatic alcohol to be reacted in the photocatalytic reaction.

In the organic reaction solution containing a photocatalyst, water added in a small amount may act as an important factor, and this is because water added in a small amount (catalytic amount) serves to improve photocatalyst oxidation/reduction by lowering an activation overpotential for oxygen reduction and aromatic alcohol oxidation of the photocatalyst. When water that is contained based on the volume of the total organic reaction solution is added at a molar ratio of 1 to 30 mol %, and preferably, 10 mol %, to the total number of molecules of the aromatic alcohol, water may contribute to increasing the photocatalytic efficiency. In addition, water may serve to transfer hydrogen ions to radicals formed in the organic reaction solution.

That is, a molar percentage of the water contained in the organic reaction solution to the total number of molecules of the aromatic alcohol may be 0 to 3 mol %, and preferably, may be 1 to 30 mol %.

When a molar percentage of water to the total number of molecules in the aromatic alcohol is within the above range, the performance of the photocatalyst is improved, such that hydrogen peroxide may be produced at a concentration higher than the maximum concentration of hydrogen peroxide that may be produced in a photoautoxidation reaction alone in which a photocatalyst is not added. When the molar percentage of water is not included within the above range but exceeds the above range, the production of hydrogen peroxide may decrease due to quenching of radicals in the reaction with water.

In the forming of the oxygen-saturated mixed solution by injecting the prepared mixed solution into the reactor and then supplying oxygen to the reactor, an oxygen supply rate may be 10 mL/min to 50 mL/min.

In the forming of the oxygen-saturated mixed solution by supplying oxygen, an oxygen supply time may be 15 min to 60 min.

In the producing of the hydrogen peroxide by irradiating the oxygen-saturated mixed solution with light, the oxygen-saturated mixed solution may be irradiated with light having a light wavelength of simulated solar light in a range of 250 nm to 900 nm.

The photoautoxidation of the hydrogen peroxide preparation process occurs by absorbing solar light having a wavelength range of 250 nm or more of the organic reaction solution. Specifically, when the organic reaction solution does not contain a photocatalyst, the wavelength range of the light source that radiates light to the organic reaction solution may be 250 nm to 400 nm, which is preferably an ultraviolet-near-visible ray region. In addition, the wavelength range of the light source that radiates light to the organic reaction solution containing a photocatalyst may include a range in which photoautoxidation occurs, and may be preferably 250 nm to 900 nm.

More specifically, when the wavelength region of light radiated to the organic reaction solution includes a range of 250 nm to 400 nm, as the wavelength region coincides with a light absorption range of the aromatic alcohol and the aromatic carbonyl group contained in the reaction solution, photoautoxidation is promoted, such that the hydrogen peroxide production capacity may be improved. In addition, the wavelength region of light radiated to the organic reaction solution to which a photocatalyst is added includes a range of 250 nm to 900 nm, as the wavelength region coincides with a light absorption range of the polymer photocatalyst injected into the organic reaction solution along with photoautoxidation, the hydrogen peroxide production capacity by the photocatalyst may be improved.

In addition, the hydrogen peroxide production reaction that occurs in the organic reaction solution may exhibit optimal efficiency in a range of an irradiance of 900 W/m² to 1,000 W/m². Preferably, the irradiance may be 950 W/m² to 1,000 W/m².

In the producing of the hydrogen peroxide by irradiating the oxygen-saturated mixed solution with light, the oxygen-saturated mixed solution may be continuously irradiated with light for 0 hours to 60 hours. However, the light irradiation time exceeds 0.

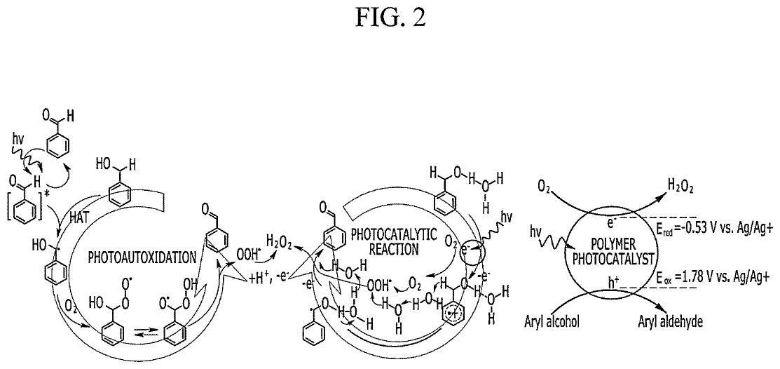

FIG. 2 illustrates a hydrogen peroxide production mechanism in a hydrogen peroxide preparation process performed by combining photoautoxidation and photocatalytic reactions.

Referring to FIG. 2, the hydrogen peroxide preparation process performed by combining photoautoxidation and photocatalytic reactions using solar light is performed in an organic reaction solution containing an aromatic carbonyl and a small amount of water, and may have the following photoautoxidation reaction mechanism 1.

### [Mechanism 1]

The photoautoxidation reaction may include the following reaction steps:
(a) forming a triplet state through inter-system crossing by optical absorption excitation of an aromatic carbonyl in an organic reaction solution;
(b) extracting a hydrogen atom from an aromatic alcohol by a triplet n, π* electronic state formed on an oxygen atom of a carbonyl having an n-orbital function;
(c) forming an α-alkyl radical by the excited aromatic carbonyl and aromatic alcohol;
(d) obtaining an aromatic carbonyl and a peroxide (OOH) radical by adding and removing oxygen molecules from the α-alkyl radical; and
(e) producing hydrogen peroxide by supplying electrons and hydrogen ions to the obtained peroxide radical.

When the aromatic alcohol is a benzyl alcohol, the step (c) of the mechanism 1 may be a step of forming an α-hydroxylbenzyl radical.

The aromatic carbonyl contained in the organic reaction solution may absorb light in the ultraviolet-near-visible region to reach an excited state, and then may form a triplet state through inter-system crossing. In this case, in the triplet n, π* electronic state formed on an oxygen atom of a carbonyl having an n-orbital function, a hydrogen atom may be extracted from a hydrogen atom donor molecule such as an aromatic alcohol. In addition, the excited aromatic carbonyl and aromatic alcohol form an α-alkyl radical. At this time, when the aromatic alcohol is a benzyl alcohol, the formed radical is an α-hydroxylbenzyl radical. The formed α-hydroxylbenzyl radical has a property of activating oxygen molecules, and an aromatic carbonyl and a peroxide (OOH) radical may be obtained through addition and removal of oxygen molecules therefrom. When electrons and hydrogen ions are supplied to the peroxide (OOH) radical produced in the organic reaction solution, hydrogen peroxide may be produced.

Referring to FIG. 2, the hydrogen peroxide preparation process performed by combining photoautoxidation and photocatalytic reactions using solar light is performed in an organic reaction solution containing an aromatic carbonyl and a small amount of water, and may have the following photocatalytic reaction mechanism 2.

### [Mechanism 2]

The photocatalytic reaction may include the following reaction steps:
(a) forming photoelectrons and holes by light absorption of a photocatalyst added to an organic reaction solution, and then reducing oxygen molecules through the photoelectrons and oxidizing an aromatic alcohol through the holes;
(b) forming a superoxide radical with the oxygen molecules reduced due to the photoelectrons and forming a radical cation with the oxidized aromatic alcohol due to the holes;
(c) forming an α-alkyl radical and a peroxide (OOH) radical by oxidizing the radical cation of the aromatic alcohol with the superoxide radical; and
(d) transferring hydrogen ions to the peroxide (OOH) radical formed by addition of a catalytic amount of water to the organic reaction solution.

When the aromatic alcohol is a benzyl alcohol, the step (c) of the mechanism 2 may be a step of forming an α-hydroxylbenzyl radical.

Hereinafter, the present invention will be described in more detail with reference to examples. However, these examples are only for illustrating the present invention, and the present invention is not limited thereto.

### (Preparation Example 1) Synthesis of Polymer Photocatalyst CTF-pH

A polymer photocatalyst used in an organic reaction solution was prepared by solid-phase polymerization of aryl nitrile molecules. Specifically, polymer photocatalyst was prepared by solid-phase polymerization of dicyanobenzene molecules through exposure to acid vapor.

The preparation method by solid-phase polymerization is as follows.

200 mg of dicyanobenzene powder was put into a Schlenk reaction vessel having a capacity of 25 ml, 0.3 ml of trifluoromethanesulfonic acid, a strong acid, was charged into a small vial, and then the vial was put into the Schlenk reaction vessel.

Then, the Schlenk reaction vessel into which the vial was put was made in a vacuum state, and then argon gas was injected into the reactor to form an argon gas atmosphere. The reaction vessel was immersed in a silicone oil bath at 100° C. to raise the temperature and maintained for 24 hours. After the reaction was completed, a solid material separated by solid-liquid separation was repeatedly washed and filtered in order using each of 100 ml of water, an NH₄OH aqueous solution, water, and acetone. The final filtered solid material was dried at a temperature of 80° C. or higher to finally obtain a polymer photocatalyst CTF-Ph.

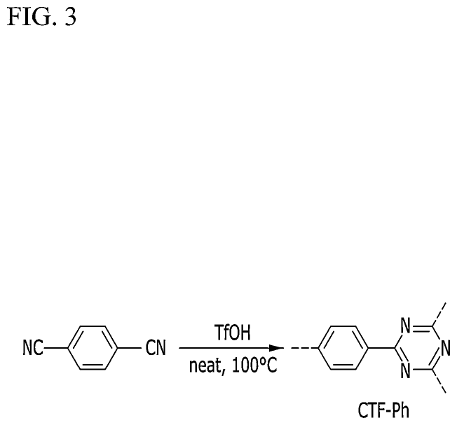

FIG. 3 illustrates a reaction formula of production of a polymer photocatalyst CTF-Ph through solid-phase polymerization of dicyanobenzene in a trifluoromethanesulfonic acid atmosphere according to Preparation Example 1.

FIG. 4 illustrates the results of analyzing light absorption characteristics of the polymer photocatalyst CTF-Ph according to Preparation Example 1.

In the present invention, the light absorption characteristics of the polymer photocatalyst CTF-Ph were analyzed with a UV visible (UV/vis) spectrophotometer. Referring to FIG. 4, it could be confirmed that CTF-Ph according to the present invention absorbed light up to a wavelength region of 430 nm and had a band gap of 2.87 eV.

FIG. 5 illustrates an oxidation/reduction potential of the polymer photocatalyst CTF-Ph, a reduction potential of oxygen, and an oxidation potential of benzyl alcohol according to Preparation Example 1. The oxygen reduction potential was-0.53 V vs. Ag/Ag⁺, and the reduction potential of CTF-Ph of the present invention was-0.70 V vs. Ag/Ag⁺. The oxidation potential of benzyl alcohol as an organic molecule was 1.78 V vs. Ag/Ag⁺, and the oxidation potential of the polymer photocatalyst CTF-Ph of the present invention was 2.17 V vs. Ag/Ag⁺. Therefore, it could be appreciated that the oxidation/reduction potential of CTF-Ph of the present invention had potential characteristics that sufficiently enable reduction of oxygen and oxidation of benzyl alcohol to occur.

Examples in which hydrogen peroxide was prepared by adding the polymer photocatalyst CTF-Ph into the organic reaction solution were shown in Examples 1-1 to 1-5.

### (Example 1-1) Hydrogen Peroxide Production Reaction Using Solar Autoxidation and Polymer Photocatalyst (Molar Percentage of Water to Aromatic Alcohol: 0 Mol %)

An organic reaction solution containing an organic solvent and an aromatic alcohol was prepared. 30 ml of an organic reaction solution containing 15 ml of acetonitrile as an organic solvent and 15 ml of a benzyl alcohol as an aromatic alcohol was prepared, and then 50 mg of the polymer photocatalyst CTF-Ph prepared by Preparation Example 1 was added to and dispersed in the organic reaction solution. The polymer photocatalyst was injected into the organic reaction solution at a concentration of 1.6 g/L, and the concentration of the polymer photocatalyst was maintained.

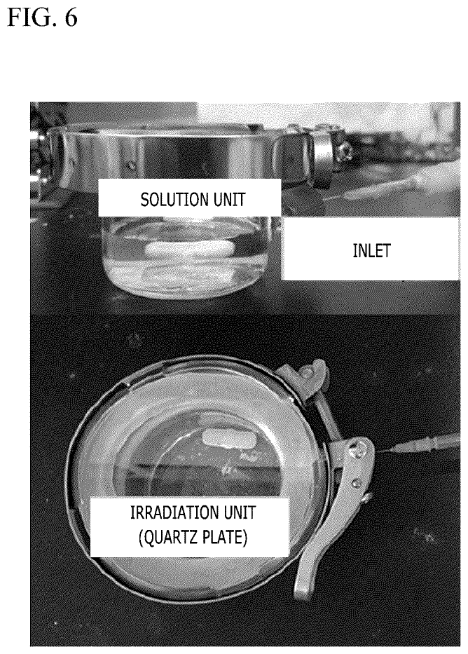

The dispersion solution was transferred to a solar reactor, and then oxygen (O₂) gas was injected for 30 minutes. Referring to FIG. 6, the solar reactor may include a solution unit which is a glass reactor for accommodating the dispersion solution, an inlet for sampling a product in the organic reactor or injecting oxygen gas, and an irradiation unit in which a quartz plate having a thickness of 1 mm capable of transmitting light is disposed. In addition, a separate light source for radiating light to the solution unit through the irradiation unit is provided.

An aeration process may be performed to fully saturate the dispersion solution with oxygen gas.

Next, while the dispersion solution in the solution unit was stirred, the solar reactor was exposed to a solar simulator (ABET technologies, Inc. (USA), Sun 3000 Class AAA, equipped with 300 W DC xenon arc lamp) for 3 hours, thereby preparing hydrogen peroxide.

The intensity of solar light irradiated was set to a maximum of 1,000 W/m².

### (Example 1-2) Hydrogen Peroxide Production Reaction Using Solar Autoxidation and Polymer Photocatalyst (Molar Percentage of Water to Aromatic Alcohol: 10 Mol %)

An organic reaction solution containing an organic solvent, an aromatic alcohol, and a small amount of water was prepared, and a molar percentage of water to the aromatic alcohol was set to 10 mol %. Hydrogen peroxide was prepared in the same manner as that of Example 1-1, except that 15 ml of a benzyl alcohol, 14.71 ml of acetonitrile, and 0.29 ml of water were contained in the organic reaction solution.

### (Example 1-3) Hydrogen Peroxide Production Reaction Using Solar Autoxidation and Polymer Photocatalyst (Molar Percentage of Water to Aromatic Alcohol: 50 Mol %)

An organic reaction solution containing an organic solvent, an aromatic alcohol, and a small amount of water was prepared, and a molar percentage of water to the aromatic alcohol was set to 50 mol %. Hydrogen peroxide was prepared in the same manner as that of Example 1-1, except that 15 ml of a benzyl alcohol, 12.4 ml of acetonitrile, and 2.6 ml of water were contained in the organic reaction solution.

### (Example 1-4) Hydrogen Peroxide Production Reaction Using Solar Autoxidation and Polymer Photocatalyst (Molar Percentage of Water to Aromatic Alcohol: 66 Mol %)

An organic reaction solution containing an organic solvent, an aromatic alcohol, and a small amount of water was prepared, and a molar percentage of water to the aromatic alcohol was set to 66 mol %. Hydrogen peroxide was prepared in the same manner as that of Example 1-1, except that 15 ml of a benzyl alcohol, 9.8 ml of acetonitrile, and 5.2 ml of water were contained in the organic reaction solution.

### (Example 1-5) Hydrogen Peroxide Production Reaction Using Solar Autoxidation and Polymer Photocatalyst (Molar Percentage of Water to Aromatic Alcohol: 98.5 Mol %)

An organic reaction solution containing an aromatic alcohol and a small amount of water was prepared, and a molar percentage of water to the aromatic alcohol was set to 98.5 mol %. Hydrogen peroxide was prepared in the same manner as that of Example 1-1, except that 3 ml of a benzyl alcohol and 27 ml of water were contained in the organic reaction solution.

Examples in which hydrogen peroxide was prepared by adding each of usable polymer photocatalysts (CTF-Ph/CTF-BPh/g-C₃N₄) other than CTF-Ph into an organic reaction solution were shown in Examples 2-1 to 2-3.

### (Example 2-1) Hydrogen Peroxide Production Reaction Using Solar Autoxidation and Structure-Modified Polymer Photocatalyst (Type of Polymer Photocatalyst: CTF-Th)

Hydrogen peroxide was prepared in the same manner as that of Example 1-1, except that a structure-modified polymer photocatalyst CTF-Th was added instead of the polymer photocatalyst CTF-Ph.

### (Example 2-2) Hydrogen Peroxide Production Reaction Using Solar Autoxidation and Structure-Modified Polymer Photocatalyst (Type of Polymer Photocatalyst: CTF-BPh)

Hydrogen peroxide was prepared in the same manner as that of Example 1-1, except that a structure-modified polymer photocatalyst CTF-BPh was added instead of the polymer photocatalyst CTF-Ph.

### (Example 2-3) Hydrogen Peroxide Production Reaction Using Solar Autoxidation and Structure-Modified Polymer Photocatalyst (Type of Polymer Photocatalyst: Graphitic Carbon Nitride (g-C₃N₄))

Hydrogen peroxide was prepared in the same manner as that of Example 1-1, except that a structure-modified polymer photocatalyst g-C₃N₄ was added instead of the polymer photocatalyst CTF-Ph.

An example in which hydrogen peroxide was prepared by a long-term reaction was shown in Example 3.

### (Example 3) Hydrogen Peroxide Production by Long-Term (50 Hours) Reaction

An organic reaction solution containing 30 ml of a benzyl alcohol as an aromatic alcohol, 29.42 ml of trifluorotoluene as an organic solvent, and 0.58 ml of water was prepared. In addition, 100 mg of a polymer photocatalyst CTF-Ph was dispersed in a total of 60 ml of the organic reaction solution. Thereafter, an aeration process was performed by charging oxygen gas into a reactor for 30 minutes. A hydrogen peroxide production reaction was performed by irradiation with light of 980 W/m² in a solar simulator. The reaction was performed for up to 50 hours, 1 ml of the reaction sample was extracted every 3 hours, and oxygen was additionally charged every 9 hours.

Examples in which hydrogen peroxide was prepared according to a concentration of the polymer photocatalyst CTF-Ph were shown in Examples 4-1 to 4-3.

### (Example 4-1) Hydrogen Peroxide Production According to Concentration of Polymer Photocatalyst CTF-pH (Concentration of CTF-pH: 1.0 g/L)

An organic reaction solution containing an organic solvent and an aromatic alcohol was prepared. Hydrogen peroxide was prepared in the same manner as that of Example 1-1, except that 20 ml of an organic reaction solution containing 10 ml of acetonitrile as an organic solvent and 10 ml of a benzyl alcohol as an aromatic alcohol was prepared, and then 20 mg of the polymer photocatalyst CTF-Ph was injected into the organic reaction solution to maintain a concentration of the polymer photocatalyst at 1.0 g/L.

### (Example 4-2) Hydrogen Peroxide Production According to Concentration of Polymer Photocatalyst CTF-pH (Concentration of CTF-pH: 2.0 g/L)

An organic reaction solution containing an organic solvent and an aromatic alcohol was prepared. Hydrogen peroxide was prepared in the same manner as that of Example 1-1, except that 10 ml of an organic reaction solution containing 5 ml of acetonitrile as an organic solvent and 5 ml of a benzyl alcohol as an aromatic alcohol was prepared, and then 20 mg of the polymer photocatalyst CTF-Ph was injected into the organic reaction solution to maintain a concentration of the polymer photocatalyst at 2.0 g/L.

### (Example 4-3) Hydrogen Peroxide Production According to Concentration of Polymer Photocatalyst CTF-pH (Concentration of CTF-pH: 4.0 g/L)

An organic reaction solution containing an organic solvent and an aromatic alcohol was prepared. Hydrogen peroxide was prepared in the same manner as that of Example 1-1, except that 5 ml of an organic reaction solution containing 2.5 ml of acetonitrile as an organic solvent and 2.5 ml of a benzyl alcohol as an aromatic alcohol was prepared, and then 20 mg of the polymer photocatalyst CTF-Ph was injected into the organic reaction solution to maintain a concentration of the polymer photocatalyst at 4.0 g/L.

Comparative examples in which hydrogen peroxide was prepared by adding an inorganic photocatalyst to an organic reaction solution were shown in Comparative Examples 1-1 to 1-5.

### (Comparative Example 1-1) Hydrogen Peroxide Production Reaction Using Solar Autoxidation and Inorganic Photocatalyst (Molar Percentage of Water to Aromatic Alcohol: 0 Mol %)

Hydrogen peroxide was prepared in the same manner as that of Example 1-1, except that an inorganic photocatalyst TiO₂ was added instead of the polymer photocatalyst CTF-Ph.

### (Comparative Example 1-2) Hydrogen Peroxide Production Reaction Using Solar Autoxidation and Inorganic Photocatalyst (Molar Percentage of Water to Aromatic Alcohol: 10 Mol %)

Hydrogen peroxide was prepared in the same manner as that of Example 1-2, except that an inorganic photocatalyst TiO₂ was added instead of the polymer photocatalyst CTF-Ph.

### (Comparative Example 1-3) Hydrogen Peroxide Production Reaction Using Solar Autoxidation and Inorganic Photocatalyst (Molar Percentage of Water to Aromatic Alcohol: 50 Mol %)

Hydrogen peroxide was prepared in the same manner as that of Example 1-3, except that an inorganic photocatalyst TiO₂ was added instead of the polymer photocatalyst CTF-Ph.

### (Comparative Example 1-4) Hydrogen Peroxide Production Reaction Using Solar Autoxidation and Inorganic Photocatalyst (Molar Percentage of Water to Aromatic Alcohol: 66 Mol %)

Hydrogen peroxide was prepared in the same manner as that of Example 1-4, except that an inorganic photocatalyst TiO₂ was added instead of the polymer photocatalyst CTF-Ph.

### (Comparative Example 1-5) Hydrogen Peroxide Production Reaction Using Solar Autoxidation and Inorganic Photocatalyst (Molar Percentage of Water to Aromatic Alcohol: 98.5 Mol %)

Hydrogen peroxide was prepared in the same manner as that of Example 1-5, except that an inorganic photocatalyst TiO₂ was added instead of the polymer photocatalyst CTF-Ph.

Comparative examples in which a photocatalyst was excluded and hydrogen peroxide was prepared by an autoxidation reaction of an organic reaction solution itself were shown in Comparative Examples 2-1 to 2-5.

### (Comparative Example 2-1) Hydrogen Peroxide Production Reaction by Solar Autoxidation (Molar Percentage of Water to Aromatic Alcohol: 0 Mol %)

Hydrogen peroxide was prepared in the same manner as that of Example 1-1, except that a polymer photocatalyst was not added.

### (Comparative Example 2-2) Hydrogen Peroxide Production Reaction by Solar Autoxidation (Molar Percentage of Water to Aromatic Alcohol: 10 Mol %)

Hydrogen peroxide was prepared in the same manner as that of Example 1-2, except that a polymer photocatalyst was not added.

### (Comparative Example 2-3) Hydrogen Peroxide Production Reaction by Solar Autoxidation (Molar Percentage of Water to Aromatic Alcohol: 50 Mol %)

Hydrogen peroxide was prepared in the same manner as that of Example 1-3, except that a polymer photocatalyst was not added.

### (Comparative Example 2-4) Hydrogen Peroxide Production Reaction by Solar Autoxidation (Molar Percentage of Water to Aromatic Alcohol: 66 Mol %)

Hydrogen peroxide was prepared in the same manner as that of Example 1-4, except that a polymer photocatalyst was not added.

### (Comparative Example 2-5) Hydrogen Peroxide Production Reaction by Solar Autoxidation (Molar Percentage of Water to Aromatic Alcohol: 98.5 Mol %)

Hydrogen peroxide was prepared in the same manner as that of Example 1-5, except that a polymer photocatalyst was not added.

A comparative example in which hydrogen peroxide was prepared from pure water using only a polymer photocatalyst CTF-Ph without applying an organic reaction solution was shown in Comparative Example 3.

### (Comparative Example 3) Hydrogen Peroxide Production Reaction in Aqueous Reaction Solution Containing Only Polymer Photocatalyst in Pure Water

Hydrogen peroxide was prepared in the same manner as that of Example 1-1, except that an organic reaction solution was not used, and an aqueous reaction solution containing 30 ml of pure water and 50 mg of a polymer photocatalyst CTF-Ph was irradiated with solar light at an intensity of 980 W/m².

Comparative examples in which hydrogen peroxide was prepared in an aqueous reaction solution having a content of alcohols (IPA or BzOH) of 10 vol % with respect to the total volume of the aqueous reaction solution and containing a polymer photocatalyst CTF-Ph were shown in Comparative Examples 4-1 and 4-2.

### (Comparative Example 4-1) Hydrogen Peroxide Production Reaction in Aqueous Reaction Solution Having Content of Isopropyl Alcohol (IPA) of 10 Vol % and Containing Polymer Photocatalyst

Hydrogen peroxide was prepared in the same manner as that of Comparative Example 3, except that an organic reaction solution was not used, and an aqueous reaction solution containing 50 mg of a polymer photocatalyst CTF-Ph and 30 ml of an aqueous solution having a volume ratio of a volume of isopropyl alcohol to the total volume of the reaction solution of 10 vol % in pure water was used.

### (Comparative Example 4-2) Hydrogen Peroxide Production Reaction in Aqueous Reaction Solution Having Content of Benzyl Alcohol (BzOH) of 10 Vol % and Containing Polymer Photocatalyst

Hydrogen peroxide was prepared in the same manner as that of Comparative Example 3, except that an organic reaction solution was not used, and an aqueous reaction solution containing 50 mg of a polymer photocatalyst CTF-Ph and 30 ml of an aqueous solution having a volume ratio of a volume of benzyl alcohol to the total volume of the reaction solution of 10 vol % in pure water was used.

### (Experimental Example 1) Analysis of Production of Hydrogen Peroxide

The production of the hydrogen peroxide prepared according to each of Examples 1-1 to 1-5, Examples 2-1 to 2-3, Example 3, Examples 4-1 to 4-3, Comparative Examples 1-1 to 1-5, Comparative Examples 2-1 to 2-5, Comparative Example 3, and Comparative Examples 4-1 and 4-2 was measured and analyzed.

The measured results of the production of the hydrogen peroxide are shown in Table 1.

TABLE 1

| | Hydrogen peroxide preparation process conditions | | | | | | | | | | | |
|---|---|---|---|---|---|---|---|---|---|---|---|---|
| | | | | | | | | Amount of | Production | Production | | Solar-to- |
| | | | | Organic | | Water to | | photo- | of | rate of | Production | chemical |
| | | Alcohol | | solvent | Water | aromatic | | catalyst | hydrogen | hydrogen | of | conversion |
| Classi- | | volume | Organic | volume | volume | alcohol | Photo- | added | peroxide | peroxide | BzCHO | efficiency |
| fication | Alcohol | (ml) | solvent | (ml) | (ml) | (mol %) | catalyst | (mg) | (mmol) | (mM/h) | (mmol) | (%) |
| Example | BzOH | 15 | Acetonitrile | 15 | 0 | 0 | CTF-Ph | 50 | 5.778 | 64.21 | 6.915 | 0.901 |
| 1-1 | | | | | | | | | | | | |
| Example | | 15 | | 14.71 | 0.29 | 10 | | 50 | 7.042 | 78.25 | 7.436 | 1.098 |
| 1-2 | | | | | | | | | | | | |
| Example | | 15 | | 12.4 | 2.6 | 50 | | 50 | 4.143 | 46.03 | 4.803 | 0.646 |
| 1-3 | | | | | | | | | | | | |
| Example | | 15 | | 9.8 | 5.2 | 66 | | 50 | 2.346 | 26.07 | 2.815 | 0.366 |
| 1-4 | | | | | | | | | | | | |
| Example | | 3 | | 0 | 27 | 98.5 | | 50 | 0.377 | 4.19 | 0.377 | 0.059 |
| 1-5 | | | | | | | | | | | | |
| Example | | 15 | | 15 | 0 | 0 | CTF-Th | 50 | 4.096 | 45.51 | 4.178 | — |
| 2-1 | | | | | | | | | | | | |
| Example | | 15 | | 15 | 0 | 0 | CTF-BPh | 50 | 5.566 | 61.84 | 6.677 | — |
| 2-2 | | | | | | | | | | | | |
| Example | | 15 | | 15 | 0 | 0 | g-C₃N₄ | 50 | 4.969 | 55.21 | 6.043 | — |
| 2-3 | | | | | | | | | | | | |
| Example 3 | | 30 | Trifluoro- | 29.42 | 0.58 | 10 | CTF-Ph | 100 | 18.491 | 6.16 | 29.650 | 0.318 |
| | | | toluene | | | | | | | | | |
| Example | | 10 | Acetonitrile | 10 | 0 | 0 | | 20 | 0.525 | — | — | — |
| 4-1 | | | | | | | | | | | | |
| Example | | 5 | | 5 | 0 | 0 | | 20 | 0.438 | — | — | — |
| 4-2 | | | | | | | | | | | | |
| Example | | 2.5 | | 2.5 | 0 | 0 | | 20 | 0.087 | — | — | — |
| 4-3 | | | | | | | | | | | | |
| Comparative | | 15 | | 15 | 0 | 0 | TiO₂ | 50 | 1.481 | 16.46 | 2.554 | 0.231 |
| Example | | | | | | | (inorganic | | | | | |
| 1-1 | | | | | | | photo- | | | | | |
| | | | | | | | catalyst) | | | | | |
| Comparative | | 15 | | 14.71 | 0.29 | 10 | | 50 | 1.694 | 18.82 | 2.979 | 0.264 |
| Example | | | | | | | | | | | | |
| 1-2 | | | | | | | | | | | | |
| Comparative | | 15 | | 12.4 | 2.6 | 50 | | 50 | 1.968 | 21.87 | 3.126 | 0.307 |
| Example | | | | | | | | | | | | |
| 1-3 | | | | | | | | | | | | |
| Comparative | | 15 | | 9.8 | 5.2 | 66 | | 50 | 0.310 | 3.44 | 1.172 | 0.048 |
| Example | | | | | | | | | | | | |
| 1-4 | | | | | | | | | | | | |
| Comparative | | 3 | | 0 | 27 | 98.5 | | 50 | 0.035 | 0.39 | 0.305 | 0.005 |
| Example | | | | | | | | | | | | |
| 1-5 | | | | | | | | | | | | |
| Comparative | | 15 | | 15 | 0 | 0 | N/A | 0 | 4.905 | 54.50 | 6.167 | 0.765 |
| Example | | | | | | | | | | | | |
| 2-1 | | | | | | | | | | | | |
| Comparative | | 15 | | 14.71 | 0.29 | 10 | | 0 | 4.656 | 51.73 | 5.735 | 0.726 |
| Example | | | | | | | | | | | | |
| 2-2 | | | | | | | | | | | | |
| Comparative | | 15 | | 12.4 | 2.6 | 50 | | 0 | 3.259 | 36.21 | 4.601 | 0.602 |
| Example | | | | | | | | | | | | |
| 2-3 | | | | | | | | | | | | |
| Comparative | | 15 | | 9.8 | 5.2 | 66 | | 0 | 1.087 | 12.08 | 1.358 | 0.170 |
| Example | | | | | | | | | | | | |
| 2-4 | | | | | | | | | | | | |
| Comparative | | 3 | | 0 | 27 | 98.5 | | 0 | 0.250 | 2.78 | 0.250 | 0.039 |
| Example | | | | | | | | | | | | |
| 2-5 | | | | | | | | | | | | |
| Comparative | N/A | 0 | N/A | 0 | 30 | 100 | CTF-Ph | 50 | 0.005 | 0.05 | — | — |
| Example 3 | | | (aqueous | | | | | | | | | |
| Comparative | IPA | 3 | reaction) | 0 | 27 | 98.5 | | 50 | 0.034 | 0.38 | — | — |
| Example | | | | | | | | | | | | |
| 4-1 | | | | | | | | | | | | |
| Comparative | BzOH | 3 | | 0 | 27 | 98.5 | | 50 | 0.377 | 4.19 | — | — |
| Example | | | | | | | | | | | | |
| 4-2 | | | | | | | | | | | | |

Specifically, the reaction solution prepared according to each of examples or comparative examples was exposed to solar light while being stirred, and about 1 ml of a sample was obtained per hour to measure production of hydrogen peroxide. At this time, production of hydrogen peroxide was quantitatively detected by a colorimetric method using a titanium sulfate solution.

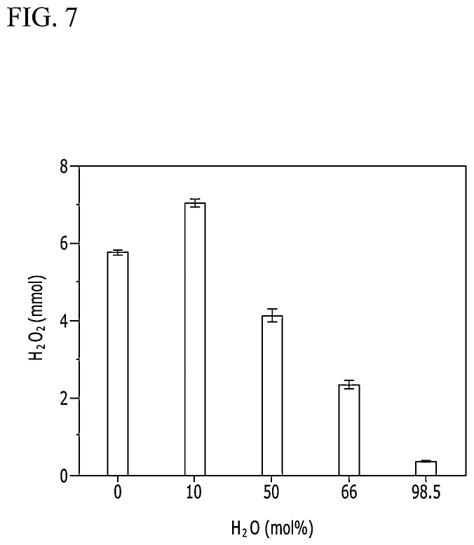

FIG. 7 illustrates production of hydrogen peroxide derived by varying a molar percentage (mol %) of water to an aromatic alcohol in the hydrogen peroxide preparation process performed using solar autoxidation and a polymer photocatalyst. That is, FIG. 7 illustrates the production of the hydrogen peroxide prepared according to each of Examples 1-1 to 1-5. When a molar percentage and a weight ratio of water to a benzyl alcohol were 10 mol % and 1 wt %, respectively, 7.04 mmol of hydrogen peroxide was produced, which achieved the maximum value. At this time, when a hydrogen peroxide production rate was calculated, the maximum production rate of 78.25 mM/h was achieved.

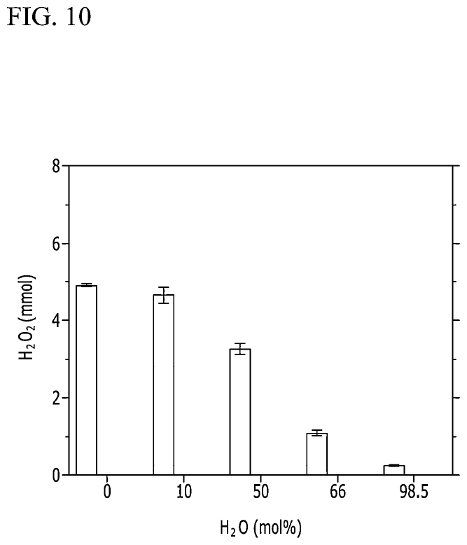

In addition, when the hydrogen peroxide production was converted into a production capacity, 46.933 mmol (h·g) (production capacity per unit time and unit catalytic amount) was achieved. FIG. 10 illustrates production of hydrogen peroxide derived by varying a molar percentage (mol %) of water to an aromatic alcohol in the hydrogen peroxide preparation process performed using solar autoxidation. That is, FIG. 10 illustrates the production of the hydrogen peroxide prepared according to each of Comparative Examples 2-1 to 2-5. When a molar percentage and a weight ratio of water to a benzyl alcohol were 0 mol % and 0 wt %, respectively, 4.9 mmol of hydrogen peroxide was produced, which achieved the maximum value.

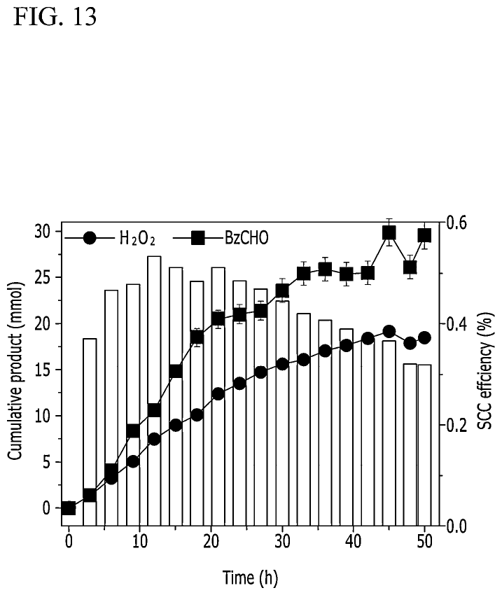

FIG. 13 illustrates production of hydrogen peroxide derived according to a reaction time up to 50 hours in the hydrogen peroxide preparation process performed by combining solar autoxidation and photocatalytic reactions for a long time. That is, FIG. 13 illustrates the production of the hydrogen peroxide prepared according to Example 3. It could be confirmed that the production of hydrogen peroxide produced during the reaction time up to 50 hours finally reached 18.5 mmol and increased almost linearly.

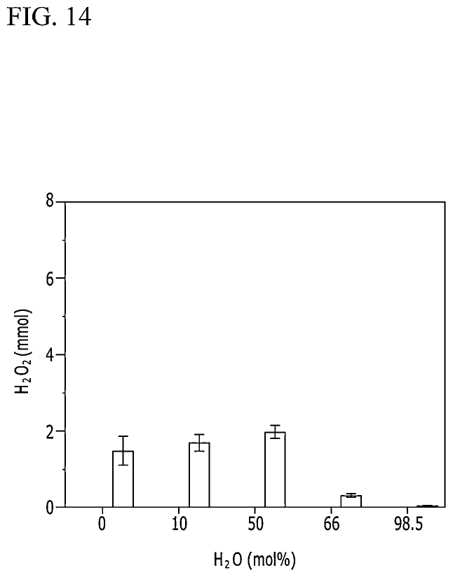

FIG. 14 illustrates production of hydrogen peroxide derived by varying a molar percentage (mol %) of water to an aromatic alcohol in the hydrogen peroxide preparation process performed using solar autoxidation and an inorganic photocatalyst TiO₂. That is, FIG. 14 illustrates the production of the hydrogen peroxide prepared according to each of Comparative Examples 1-1 to 1-5. When a molar percentage and a weight ratio of water to a benzyl alcohol were 50 mol % and 8.7 wt %, respectively, 1.97 mmol of hydrogen peroxide was produced, which achieved the maximum value.

In Table 1, N/A represents that the corresponding material is not contained in the hydrogen peroxide preparation process conditions.

### (Experimental Example 2) Analysis of Production of Benzaldehyde (BzCHO) as Oxidized Organic Product

The production of the oxidized organic product prepared according to each of Examples 1-1 to 1-5, Examples 2-1 to 2-3, Example 3, Comparative Examples 1-1 to 1-5, and Comparative Examples 2-1 to 2-5 was measured and analyzed.

The measurement results of the production of the oxidized organic products are shown in Table 1.

Specifically, the reaction solution prepared according to each of examples or comparative examples was exposed to solar light while being stirred, and about 1 ml of a sample was obtained per hour to measure production of an oxidized organic product. At this time, a concentration of the organic product was quantitatively analyzed by gas chromatograph.

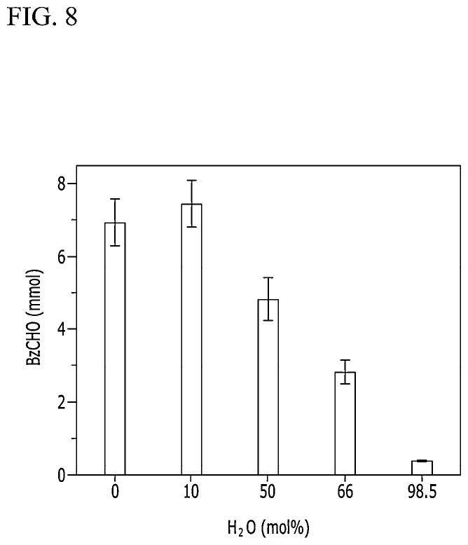

FIG. 8 illustrates production of benzaldehyde (BzCHO) as an oxidized organic product derived by varying a molar percentage (mol %) of water to an aromatic alcohol in the hydrogen peroxide preparation process performed using solar autoxidation and a polymer photocatalyst. That is, FIG. 8 illustrates the production of the benzaldehyde prepared according to each of Examples 1-1 to 1-5. When a molar percentage and a weight ratio of water to a benzyl alcohol were 10 mol % and 1 wt %, respectively, 7.44 mmol of benzaldehyde was produced, which achieved the maximum value.

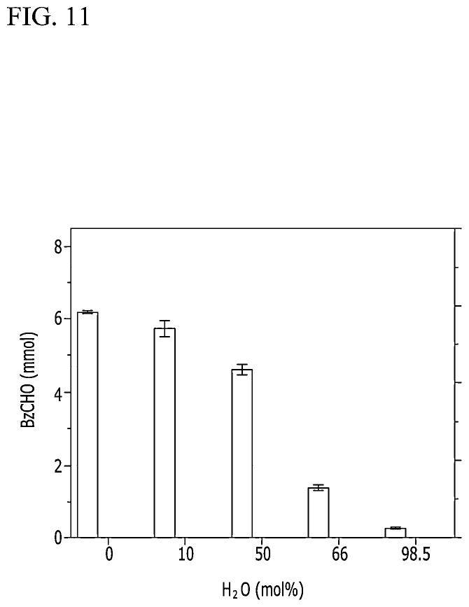

FIG. 11 illustrates production of benzaldehyde as an oxidized organic product derived by varying a molar percentage (mol %) of water to an aromatic alcohol in the hydrogen peroxide preparation process performed using solar autoxidation. That is, FIG. 11 illustrates the production of the hydrogen peroxide prepared according to each of Comparative Examples 2-1 to 2-5. When a molar percentage and a weight ratio of water to a benzyl alcohol were 0 mol % and 0 wt %, respectively, 6.17 mmol of benzaldehyde was produced, which achieved the maximum value.

FIG. 13 illustrates production of benzaldehyde as an oxidized organic product derived according to a reaction time up to 50 hours in the hydrogen peroxide preparation process performed by combining solar autoxidation and photocatalytic reactions for a long time. That is, FIG. 13 illustrates the production of the benzaldehyde prepared according to Example 3. It could be confirmed that the production of benzaldehyde produced during the reaction time up to 50 hours finally reached 29.6 mmol and increased almost linearly.

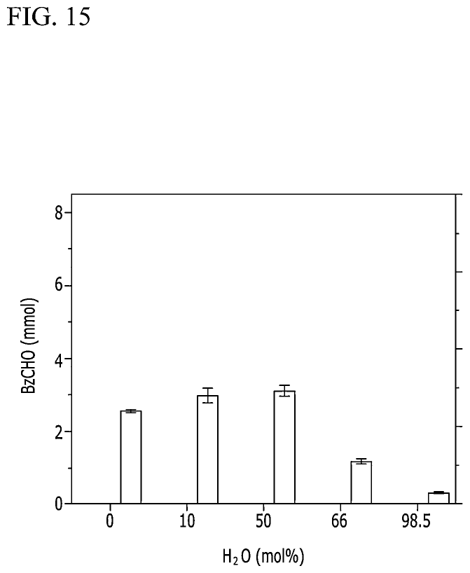

FIG. 15 illustrates production of benzaldehyde derived by varying a molar percentage (mol %) of water to an aromatic alcohol in the hydrogen peroxide preparation process performed using solar autoxidation and an inorganic photocatalyst TiO₂. That is, FIG. 15 illustrates the production of the benzaldehyde prepared according to each of Comparative Examples 1-1 to 1-5. When a molar percentage and a weight ratio of water to a benzyl alcohol were 50 mol % and 8.7 wt %, respectively, 3.13 mmol of benzaldehyde was produced, which achieved the maximum value.

### (Experimental Example 3) Solar-to-Chemical Conversion Efficiency (SCC Efficiency) of Hydrogen Peroxide Preparation Process

The solar-to-chemical conversion efficiency of the hydrogen peroxide preparation process according to each of Examples 1-1 to 1-5, Example 3, Comparative Examples 1-1 to 1-5, and Comparative Examples 2-1 and 2-5 were calculated and analyzed.

The calculation results of the solar-to-chemical conversion efficiency are shown in Table 1.

The solar-to-chemical conversion (SCC) efficiency was calculated by the following equation.

$$SSC efficiency ( \% ) = \frac{[ Δ G for {H}_{2} {O}_{2} production ( J {mol}^{- 1} ) ] [ {H}_{2} {O}_{2} formed ( mol ) ]}{[ Total input power ( W ) ] [ Reaction time ( s ) ]} \times 100$$

At this time, a change in free energy of hydrogen peroxide was calculated using ΔG=117 KJ mol⁻¹ and Power=solar light irradiation intensity (980.88 W m⁻²)×irradiation area (0.007088 m²). The reaction time (sec) was applied in terms of 3 hours.

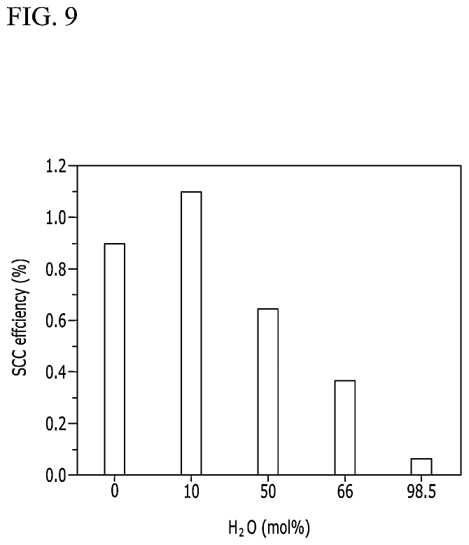

FIG. 9 illustrates solar-to-chemical conversion efficiency (SCC efficiency) during a 3-hour hydrogen peroxide production derived by varying a molar percentage (mol %) of water to an aromatic alcohol in the hydrogen peroxide preparation process using solar autoxidation and a polymer photocatalyst. That is, FIG. 9 illustrates the solar-to-chemical conversion efficiency derived according to each of Examples 1-1 to 1-5. When a molar percentage and a weight ratio of water to a benzyl alcohol were 10 mol % and 1 wt %, respectively, the solar-to-chemical conversion efficiency achieved the maximum value of 1.097%. In addition, the solar-to-chemical conversion efficiency has achieved the world's highest level at this time.

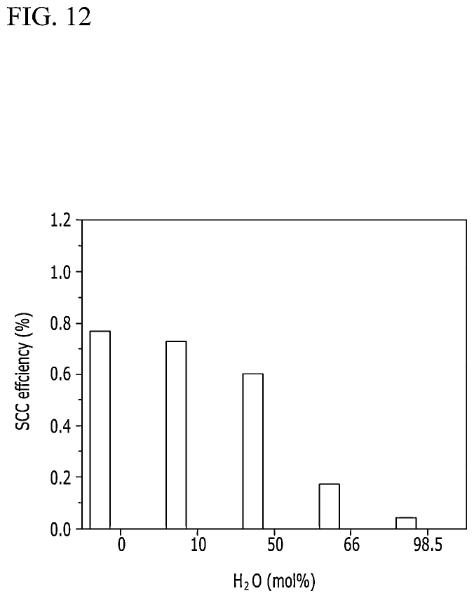

FIG. 12 illustrates solar-to-chemical conversion efficiency (SCC efficiency) during a 3-hour hydrogen peroxide production derived by varying a molar percentage (mol %) of water to an aromatic alcohol in the hydrogen peroxide preparation process using solar autoxidation. That is, FIG. 12 illustrates the solar-to-chemical conversion efficiency derived according to each of Comparative Examples 2-1 to 2-5. When a molar percentage and a weight ratio of water to a benzyl alcohol were 0 mol % and 0 wt %, respectively, the solar-to-chemical conversion efficiency achieved the maximum value of 0.76%. It could be confirmed that the solar-to-chemical conversion efficiency was lower than the solar-to-chemical conversion efficiency of the hydrogen peroxide preparation process performed by combining solar autoxidation and photocatalytic reactions, but was superior to that of the photocatalytic hydrogen peroxide production capacity according to the related art.

FIG. 13 illustrates the solar-to-chemical conversion efficiency derived by measuring the production of hydrogen peroxide every 3 hours for the reaction time up to 50 hours in the hydrogen peroxide preparation process performed by combining solar autoxidation and photocatalytic reactions for a long time. That is, FIG. 13 illustrates the solar-to-chemical conversion efficiency according to the production of hydrogen peroxide produced every 3 hours according to Example 3. It could be confirmed that the solar-to-chemical conversion efficiency was maintained at 0.32%, which was high, even after a long reaction time of up to 50 hours.

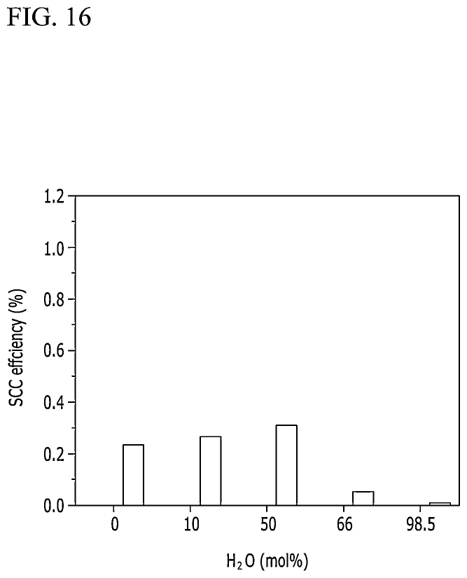

FIG. 16 illustrates solar-to-chemical conversion efficiency (SCC efficiency) during a 3-hour hydrogen peroxide production derived by varying a molar percentage (mol %) of water to an aromatic alcohol in the hydrogen peroxide preparation process using solar autoxidation and an inorganic photocatalyst TiO₂. That is, FIG. 16 illustrates the solar-to-chemical conversion efficiency derived according to each of Comparative Examples 1-1 to 1-5. When a molar percentage and a weight ratio of water to a benzyl alcohol were 50 mol % and 8.7 wt %, respectively, the solar-to-chemical conversion efficiency achieved the maximum value of 0.31%.

Comparing FIGS. 7 and 10, FIGS. 8 and 11, and FIGS. 9 and 12, respectively, it could be confirmed that, in Examples 1-1 to 1-5 corresponding to the process performed by combining autoxidation and a photocatalyst, more improved hydrogen peroxide and oxidized organic product production capacities and solar-to-chemical conversion efficiency were derived compared to those in Comparative Examples 2-1 to 2-5 in which the process was performed using only autoxidation under same conditions.

According to Experimental Examples 1 to 3, it could be confirmed that, in the autoxidation reaction of the organic reaction solution alone, the production capacity was reduced even when only 1 wt % of water was added in terms of weight ratio in the total reaction in the reaction solution, but in a case where a photocatalyst coexisted, the reaction and production capacity were slightly improved when water was added. This was because in the reaction of the photocatalyst, water formed a hydrogen bond with an organic molecule to be reacted to lower the oxidation potential. In the organic reaction solution, the activation of oxygen molecules was promoted through autoxidation of a medium itself, and a large amount of OOH radicals, which were intermediates of hydrogen peroxide, was produced. At this time, the hydrogen ions and electrons required to convert the OOH radicals into hydrogen peroxide could be supplied through the polymer photocatalyst. Therefore, more improved hydrogen peroxide was produced through synergistic coupling between the photocatalytic reaction and the autoxidation reaction in the organic reaction solution.

In addition, referring to FIG. 13, it could be confirmed that hydrogen peroxide and organic products at high concentrations were stably produced in a large scale and longer reaction process. Therefore, it could be appreciated that when the organic reaction solution was used, hydrogen peroxide was stably produced using light.

In addition, comparing FIGS. 7 and 14, FIGS. 8 and 15, and FIGS. 9 and 16, respectively, it could be confirmed that, in Examples 1-1 to 1-5 corresponding to the process performed by combining autoxidation and a polymer photocatalyst, more excellent hydrogen peroxide and oxidized organic product production capacities and solar-to-chemical conversion efficiency were derived compared to those in Comparative Examples 1-1 to 1-5 in which the hydrogen peroxide preparation process in which a polymer photocatalyst was substituted with an inorganic photocatalyst was performed under the same conditions.

It could be confirmed that the production capacity was greatly reduced when the polymer photocatalyst was substituted with an inorganic photocatalyst in the organic reaction solution. In the case of titanium dioxide (TiO₂) as the most used inorganic photocatalyst, the reduction potential was −0.47 V vs. Ag/Ag⁺ and the oxidation potential was 2.67 V vs. Ag/Ag⁺. Although the potential was at a level where reduction of oxygen and oxidation of organic molecules were possible, as illustrated in FIGS. 14 and 15, when TiO₂ was used in an organic reaction solution instead of a polymer photocatalyst, it could be confirmed that hydrogen peroxide and oxidized organic products were produced in amounts of up to 1.97 mmol and 3.13 mmol, respectively, under the same process conditions as in Examples 1-1 and 1-5. It could be confirmed that the efficiency of the organic reaction solution using TiO₂ was much lower than the efficiency of the autoxidation reaction alone of the organic reaction solution itself presented in Comparative Examples 2-1 to 2-5.

It could be appreciated that the production capacity of the photoreaction-based hydrogen peroxide preparation process using an organic reaction solution could be greatly influenced not only by autoxidation but also by the type of photocatalyst used. That is, as disclosed in the present invention, it could be confirmed that, when the polymer photocatalyst was added to the organic reaction solution, the reaction efficiency was more excellent than that of an inorganic photocatalyst, and the polymer photocatalyst was more suitable for the hydrogen peroxide preparation process.

### (Experimental Example 4) Analysis of Photocatalytic Hydrogen Peroxide Decomposition Behavior when Hydrogen Peroxide (10 mM) Contained in Organic Reaction Solution was Irradiated with Solar Light Under Oxygen-Free Argon Atmosphere

When hydrogen peroxide was arbitrarily added to the organic reaction solution at a concentration of 10 mM and was irradiated with light under an argon atmosphere, the decomposition of hydrogen peroxide by the polymer photocatalyst and the inorganic photocatalyst was examined by observing a hydrogen peroxide concentration change (C/C₀). In this case, C₀ represents the initial hydrogen peroxide concentration, and C represents the hydrogen peroxide concentration for each decomposition reaction time.

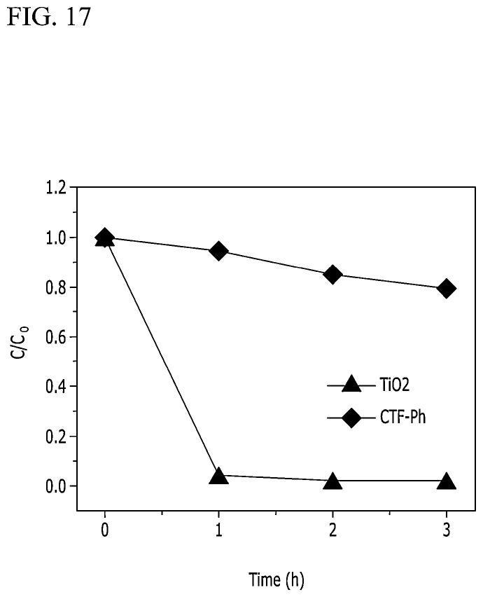

FIG. 17 illustrates the hydrogen peroxide decomposition behavior according to the type of photocatalyst. Comparing the C/C₀ values in detail in the graph, it could be confirmed that, in a case where the inorganic photocatalyst TiO₂ was contained, when the reaction time was 1 hour, the C/C₀ value reached 0.034, and when the reaction time was 3 hours, the C/C₀ value reached 0.012. On the other hand, it could be confirmed that, in a case where the polymer photocatalyst CTF-Ph was contained, when the reaction time was 1 hour, the C/C₀ value reached 0.945, and when the reaction time was 3 hours, the C/C₀ value reached 0.795. That is, referring to FIG. 17, it could be confirmed that the inorganic photocatalyst TiO₂ decomposed hydrogen peroxide much faster than the polymer photocatalyst CTF-Ph. Therefore, it could be appreciated that the polymer photocatalyst was more suitable for the hydrogen peroxide preparation process using an organic reaction solution.

### (Experimental Example 5) Comparison of Hydrogen Peroxide Production Reaction Efficiency According to Type of Electron Donor in Aqueous Reaction Environment

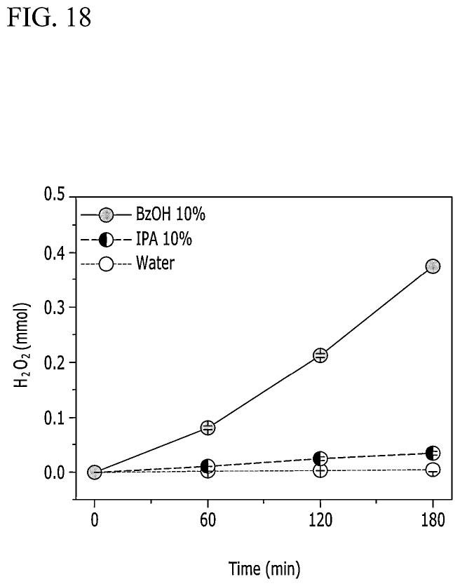

Hydrogen peroxide was prepared according to each of Comparative Example 3 and Comparative Examples 4-1 and 4-2, and the concentrations of hydrogen peroxide produced when the type of electron donor was changed in an aqueous reaction environment were compared. The results thereof are illustrated in FIG. 18.

FIG. 18 illustrates production of hydrogen peroxide when 50 mg of a polymer photocatalyst CTF-Ph was added to 30 ml of an aqueous reaction solution and irradiation was performed with solar light of 980 W/m². Through this, it could be confirmed that the production efficiency was insignificant in the case of the hydrogen peroxide preparation process using the polymer photocatalyst CTF-Ph under general aqueous conditions. Referring to FIG. 18, 4.9 μmol of hydrogen peroxide was produced in pure water. In the case where 10% isopropyl alcohol (IPA) was used as an electron donor in an aqueous reaction solution, it was confirmed that the production of hydrogen peroxide was increased to 34.3 μmol, and in the case where 10% benzyl alcohol (BzOH) was used as an electron donor in an aqueous reaction solution, it was confirmed that the production of hydrogen peroxide was increased up to 377.2 μmol. Therefore, it could be appreciated that, in a case where the polymer photocatalytic reaction occurred in an aqueous system, when the type of electron donor was changed to water, IPA, or BzOH, the oxidation reaction was promoted, such that photoelectron production was promoted, resulting in an increase of production efficiency of hydrogen peroxide by oxygen reduction.

### (Experimental Example 6) Analysis of Rotating Ring-Disk Electrode Voltammogram (RRDE)

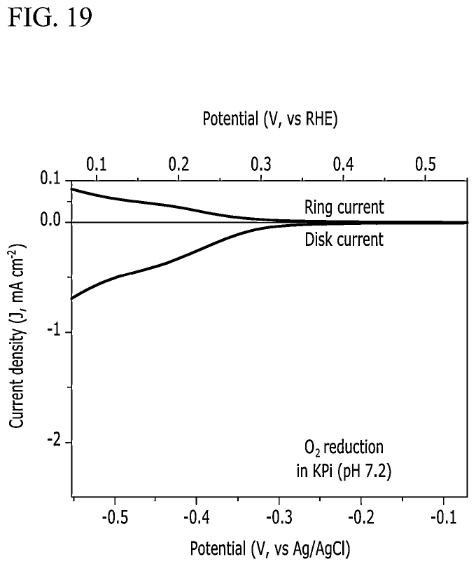

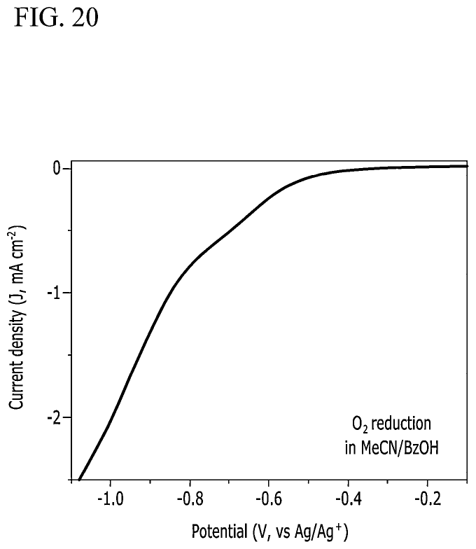

FIGS. 19 and 20 illustrate the results of measuring a change in reduction performance of oxygen of the polymer photocatalyst CTF-Ph in each of aqueous and organic-based environments with a rotating ring-disk electrode voltammogram (RRDE). The aqueous reaction environment was 0.1 M phosphate buffer (KPi, pH 7.2), and the organic-based reaction environment was created with 0.1 M benzyl alcohol (BzOH) and acetonitrile (MeCN)-0.1 M tetrabutylammonium hexafluorophosphate (TBAPF₆). At this time, the Pt ring electrode applied voltage was set to 1.0 V vs. Ag/AgCl.

In FIGS. 19 and 20, the disk electrode current density is a measure of a degree of oxygen reduction. It could be confirmed that the disk electrode current density was greatly increased in the organic-based environment (FIG. 20) than in the aqueous environment (FIG. 19). That is, it could be appreciated that the oxygen reduction performance of the polymer photocatalyst was greatly improved in the organic-based reaction environment than in the aqueous reaction environment. Therefore, it could be appreciated that the hydrogen peroxide preparation process using an organic reaction solution was greatly advantageous compared to the aqueous reaction.

### (Experimental Example 7) Comparison of Oxidation/Reduction Potentials of Polymer Photocatalysts

The representative polymer photocatalyst used in the present invention is CTF-Ph, but the polymer photocatalyst applicable to the organic reaction solution is not limited to CTF-Ph. The reaction was performed under the same conditions as those in Examples 1-1 to 1-5, but the type of polymer photocatalyst was changed to each of CTF-Th, CTF-BPh, and graphitic carbon nitride (g-C₃N₄), thereby deriving the hydrogen peroxide production capacity.

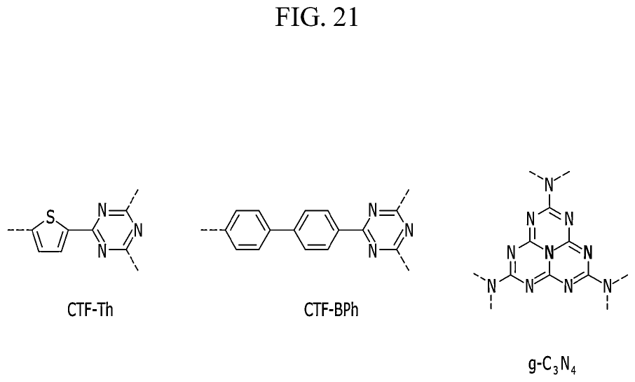

FIG. 21 illustrates the structure of the polymer photocatalyst comparative groups CTF-Th, CTF-BPh, and graphitic carbon nitride (g-C₃N₄) applied in Experimental Example 7 of the present invention.

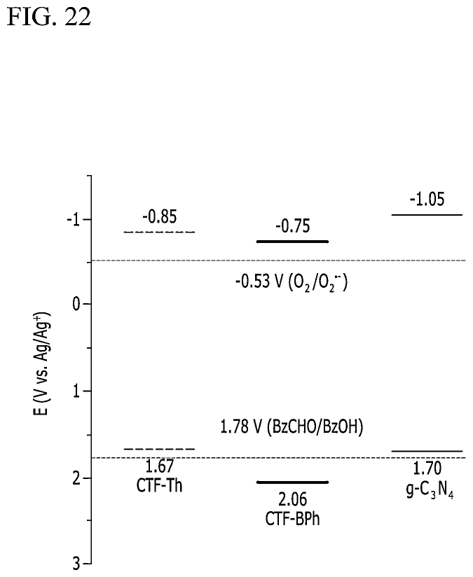

The oxidation/reduction potentials of the photocatalysts belonging to the comparative groups are illustrated in FIG. 22. The reduction potential of oxygen was-0.53 V vs. Ag/Ag⁺, and the oxidation potential of benzyl alcohol as an organic molecule was-1.78 V vs. Ag/Ag⁺. The reduction potential of oxygen and the oxidation potential of the organic molecule described above were generally included in the oxidation/reduction potential of the disclosed polymer comparative group.

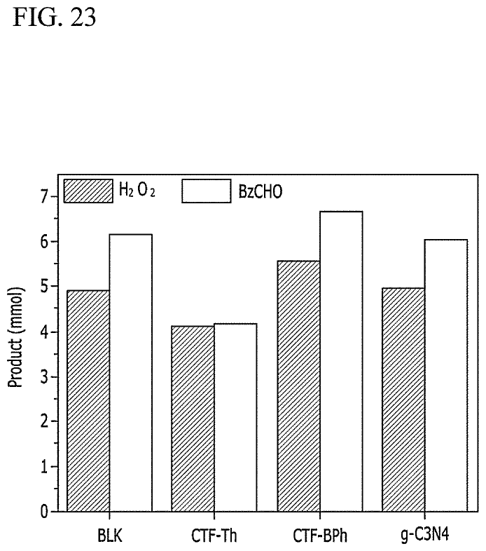

FIG. 23 illustrates the production capacity of hydrogen peroxide and oxidized organic product (BzCHO) of the polymer photocatalyst comparative group in the organic reaction solution. Referring to FIG. 23, even when one of the polymer photocatalyst comparative groups was applied under the reaction conditions as in Examples 1-1 and 1-5, as in the case of applying CTF-Ph as a polymer photocatalyst, hydrogen peroxide and an oxidized organic product (benzaldehyde, BzCHO) was obtained at a high concentration. It could be appreciated that the capacity described above was a major difference compared to the inorganic photocatalyst presented in Comparative Examples 1-1 to 1-5, and various polymer photocatalysts could be used in the organic reaction solution.

### (Experimental Example 8) Comparison of Production of Hydrogen Peroxide According to Concentration of Polymer Photocatalyst CTF-pH

The production values of hydrogen peroxide prepared according to Examples 4-1 to 4-3 were compared and analyzed.

FIG. 24 illustrates the production of hydrogen peroxide according to the concentration of the polymer photocatalyst CTF-Ph in the organic reaction solution.

It could be confirmed that the production of hydrogen peroxide prepared according to each of examples of the present invention increased as the concentration of the polymer photocatalyst decreased within the numerical range of the concentration of the polymer photocatalyst CTF-Ph of 1.0 g/L to 4.0 g/L.

What is claimed is:

1. A hydrogen peroxide preparation process performed by combining photoautoxidation and photocatalytic reactions using solar light, the hydrogen peroxide preparation process comprising:
preparing a mixed solution by mixing a photocatalyst and a photoautoxidative organic reaction solution;
forming a mixed solution by injecting the prepared mixed solution into a reactor;
forming an oxygen-saturated mixed solution by supplying oxygen to the reactor; and
producing hydrogen peroxide by irradiating the oxygen-saturated mixed solution with light.

2. The hydrogen peroxide preparation process of claim 1, wherein:
in the preparing of the mixed solution by mixing the photocatalyst and the photoautoxidative organic reaction solution,
a concentration of the photocatalyst dispersed in the photoautoxidative organic reaction solution is 0.1 g/L to 4.0 g/L.

3. The hydrogen peroxide preparation process of claim 1, wherein:
in the preparing of the mixed solution by mixing the photocatalyst and the photoautoxidative organic reaction solution,
the photocatalyst is a polymer photocatalyst, and
the polymer photocatalyst includes one or more selected from CTF-Ph, CTF-Th, CTF-BPh, and graphitic carbon nitride (g-C₃N₄).

4. The hydrogen peroxide preparation process of claim 1, wherein:
in the preparing of the mixed solution by mixing the photocatalyst and the photoautoxidative organic reaction solution,
a reduction potential of the photocatalyst is included in a range of −1.25 to −0.50 V vs. Ag/Ag⁺, and an oxidation potential of the photocatalyst is included in a range of 1.65 to 2.70 V vs. Ag/Ag⁺.

5. The hydrogen peroxide preparation process of claim 1, wherein:
in the preparing of the mixed solution by mixing the photocatalyst and the photoautoxidative organic reaction solution,
the photoautoxidative organic reaction solution is obtained by mixing an aromatic alcohol, an organic solvent, and water.

6. The hydrogen peroxide preparation process of claim 5, wherein:
an aromatic carbonyl compound is additionally mixed.

7. The hydrogen peroxide preparation process of claim 6, wherein:
the aromatic carbonyl compound to be additionally mixed is one or more selected from an aromatic ketone and an aromatic aldehyde.

8. The hydrogen peroxide preparation process of claim 7, wherein:
the aromatic ketone or the aromatic aldehyde is one or more selected from benzaldehyde (BzCHO), 9-anthracenecarboxaldehyde, 9-anthraldehyde, fluorene-2-carboxaldehyde, 9-phenanthrenecarboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, anthraquinone, fluorenone, and acetophenone.

9. The hydrogen peroxide preparation process of claim 5, wherein:
the aromatic alcohol is partially oxidized and contains an aromatic carbonyl compound in an amount of 0.1 wt % to 0.2 wt % with respect to the total weight of the aromatic alcohol.

10. The hydrogen peroxide preparation process of claim 6, wherein:
the aromatic carbonyl compound is additionally mixed in an amount of 0.001 wt % to 30 wt % with respect to the total weight of the mixture of the aromatic alcohol, organic solvent, water, and additionally mixed aromatic carbonyl compound.

11. The hydrogen peroxide preparation process of claim 5, wherein:
the aromatic alcohol is one or more selected from the group consisting of benzyl alcohols substituted with electron-withdrawing and electron-donating functional groups.

12. The hydrogen peroxide preparation process of claim 11, wherein:
the benzyl alcohols substituted with the electron-withdrawing and electron-donating functional groups include benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

13. The hydrogen peroxide preparation process of claim 5, wherein:
the organic solvent has a solubility of oxygen of 1 mM to 15 mM based on 1 atm.

14. The hydrogen peroxide preparation process of claim 5, wherein:
the organic solvent is one or more selected from trifluorotoluene, acetonitrile, methanol, ethanol, tert-butanol, 1-propanol, 2-propanol, acetone, ethyl acetate, tert-amyl alcohol, 1-butanol, petroleum ether, diethyl ether, pentane, pentanol, cyclohexane, n-hexane, octane, octanol, decane, decanol, heptane, heptanol, dichloromethane, chloroform, tetrahydrofuran, 1,4-dioxane, dimethyl sulfoxide (DMSO), dimethylformamide, benzene, toluene, xylene, and styrene.

15. The hydrogen peroxide preparation process of claim 5, wherein:
the organic solvent includes a hydrophobic organic solvent,
the hydrophobic organic solvent is represented by the following Equation 1,
Octanol-water partition coefficient=log P=log([C_{oct}]/[C_{water}]) [Equation 1]
in Equation 1, [C_{oct}] represents a molar concentration of an organic solvent dissolved in an octanol layer, and [C_{water}] represents a molar concentration of an organic solvent dissolved in a water layer, and
an octanol-water partition coefficient (log P) value is 0 or greater.

16. The hydrogen peroxide preparation process of claim 5, wherein:
the water is contained in an amount of 0 to 30 mol % with respect to the total weight of the aromatic alcohol contained in the organic reaction solution.

17. The hydrogen peroxide preparation process of claim 1, wherein:
in the forming of the oxygen-saturated mixed solution by injecting the prepared mixed solution into the reactor and then supplying oxygen to the reactor,
an oxygen supply rate is 10 mL/min to 50 mL/min.

18. The hydrogen peroxide preparation process of claim 1, wherein:
in the forming of the oxygen-saturated mixed solution by injecting the prepared mixed solution into the reactor and then supplying oxygen to the reactor,
an oxygen supply time is 15 min to 60 min.

19. The hydrogen peroxide preparation process of claim 1, wherein:
in the producing of the hydrogen peroxide by irradiating the oxygen-saturated mixed solution with light,
the oxygen-saturated mixed solution is irradiated with light having a light wavelength range of 250 to 900 nm.

20. The hydrogen peroxide preparation process of claim 1, wherein:
in the producing of the hydrogen peroxide by irradiating the oxygen-saturated mixed solution with light,
the oxygen-saturated mixed solution is irradiated with light for 0 to 60 hours, and
the light irradiation time exceeds 0.

21. The hydrogen peroxide preparation process of claim 1, wherein:
in the producing of the hydrogen peroxide by irradiating the oxygen-saturated mixed solution with light,
the oxygen-saturated mixed solution is irradiated with light having an irradiance of 900 to 1,000 W/m².
